(19) United States
(12) Patent Application Publication
(10) Pub. No.: US 2012/0132411 A1
(43) Pub. Date: May 31, 2012

(54) WIND POWER GENERATING SYSTEM FOR VEHICLE USING MOTOR FOR COOLING FAN

(75) Inventors: Man-Hee Park, Sungnam-shi (KR); Jae-San Kim, Yongin-si (KR); Jae-Yeon Kim, Hwasung-shi (KR); Yong-Hyun Choi, Hwasung-shi (KR)

(73) Assignee: Hyundai Motor Company, Seoul (KR)

(21) Appl. No.: 13/230,510

(22) Filed: Sep. 12, 2011

(30) Foreign Application Priority Data
Nov. 26, 2010 (KR) 10-2010-118477

(51) Int. Cl. B60H 1/00

(52) U.S. Cl. 165/271

(57) ABSTRACT

Provided is a wind power generating system for a vehicle using a cooling fan motor that is operated by receiving power from a battery, the system including a cooling fan motor operated in a cooling mode to cool a heat exchanger with the applied power or operated in a power generation mode to produce electricity by rotating a cooling fan by driving wind, and a control device controlling rotation of the cooling fan motor and determining whether the cooling fan motor is operated in the power generation mode or the cooling mode.

### CROSS-REFERENCE TO RELATED APPLICATIONS

This application claims priority under 35 U.S.C. §119 to Korean Patent Application No. 10-2010-118477 filed on Nov. 26, 2010, the entire contents of which application is incorporated herein for all purposes by this reference.

### BACKGROUND OF INVENTION

1. Field of Invention

The present invention relates to a wind power generating system for a vehicle using a motor for a cooling fan, and more particularly, to a wind power generating system for a vehicle configured to generate a motor for a cooling fan and individually perform a cooling or power generating function actively depending on the temperature of cooling water and the speed of the vehicle.

2. Description of Related Art

When temperature rises by combustion gas generated from an engine, the rigidities of internal parts are deteriorated, and as a result, damages occur. A cooling device of a vehicle is installed to prevent the damages. A water-cooling type cooling system using circulation of cooling water is routinely used in the vehicle. In the water-cooling type cooling system, a path allowing the cooling water to be circulated is installed in a body of the engine to circulate the cooling water and a heat exchanger is installed in front of an engine room of the vehicle to cool heated cooling water by using outside air. In addition, a cooling fan is mounted in order that more outside air can be introduced into the heat exchanger. Further, in general, since a heat exchanger (a condenser) of an air-conditioning apparatus is positioned in front of the heat exchanger, the cooling fan serves to additionally promote heat dissipation of the heat exchanger for the air-conditioning apparatus.

Meanwhile, the known cooling fan is connected by wiring from a main battery of the vehicle. An engine ECU controls power supplied from a battery to a motor by using a relay or a cooling fan controller through au automatic logic of the cooling fan to drive the cooling fan. That is, the motor rotating the cooling fan has a rotation speed determined according to the level of voltage supplied from the main battery and is configured by a one-way circuit. Therefore, the motor is a system that cannot generate and store electricity.

Meanwhile, power generating systems using driving wind have been developed in order to improve fuel efficiency of the vehicle. However, in the known system, a wind power generating fan is installed at a front grill part of the vehicle, a side mirror side, a bumper side, and the like to which the driving wind is blown from the front and when the vehicle travels, the fan is rotated to generate electricity. Therefore, the known system injures the beauty of the vehicle and acts as a load to the vehicle in the case of routine driving in which power generation is not made, so that it cannot offer practical advantages in terms of effect.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a wind power generating system for a vehicle that can perform wind power generation by using a known motor for a cooling fan without newly installing an additional fan so as to prevent the fan from serving as a load, even in the case of routine driving.

Various aspects of the present invention provide for a wind power generating system for a vehicle using a cooling fan motor that is actuated by receiving power from a main battery according to a signal from an (engine) ECU, the system including a cooling fan motor actuated in a cooling mode to cool a heat exchanger with the applied power or actuated in a power generation mode to produce electricity by rotating a cooling fan by driving wind, and a control device controlling the power of the cooling fan motor by communicating with the engine ECU and determining whether the cooling fan motor is operated in the power generation mode or the cooling mode.

The system may further include an auxiliary battery storing DC electricity. That is, the control device may store selectively in the main battery or the auxiliary battery the electricity produced from the cooling fan motor operated in the power generation mode. In addition, the auxiliary battery and the main battery may supply the stored electricity to each other according to a charging state of each battery.

Further, the auxiliary battery may supply electricity to the main battery through a charging circuit of an alternator charging a battery by producing electricity through rotation of the engine.

The control device determines the operation of the cooling fan motor according to a predetermined control logic and the control logic is in advance determined and set for each condition by using the temperature of cooling water and the speed of the vehicle as variables.

Since the cooling fan also serves to cool a heat exchanger of an air-conditioning apparatus, the variables of the control logic may further include an on/off state and/or refrigerant pressure of the air-conditioning apparatus. Moreover, the control device may communicate with a controller of other devices (such as an ECU, a FATC, an HCU, and the like) that sense data regarding the temperature of the cooling water, the speed of the vehicle, and the refrigerant pressure so as to exclude addition of duplicated devices.

According to various aspects of the present invention, since electricity is produced without deteriorating the driving performance of a vehicle, energy consumption rate (i.e., fuel efficiency) can be reduced.

Further, production of additional electricity can cause capacitance of an alternator and the manufacturing cost of related parts to be reduced and as generable electric capacitance increases, the reliability of electric devices can be improved.

Moreover, since the known cooling fan is used without adding a fan for power generation, cost added for production is minimized and a change in an internal layout of the vehicle can be minimized, such that various embodiments of the present invention can be easily applied even to the existing vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a conceptual diagram showing a configuration of an exemplary wind power generating system for a vehicle using a cooling fan motor according to the present invention.

FIGS. 2A and 2B are conceptual diagrams showing a configuration of an exemplary wind power generating system for a vehicle using a cooling fan motor according to the present invention.

FIG. 3 is a conceptual diagram showing a configuration of an exemplary wind power generating system for a vehicle using a cooling fan motor according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a wind power generating system for a vehicle using a cooling fan motor according to various embodiments of the present invention will be described in more detail.

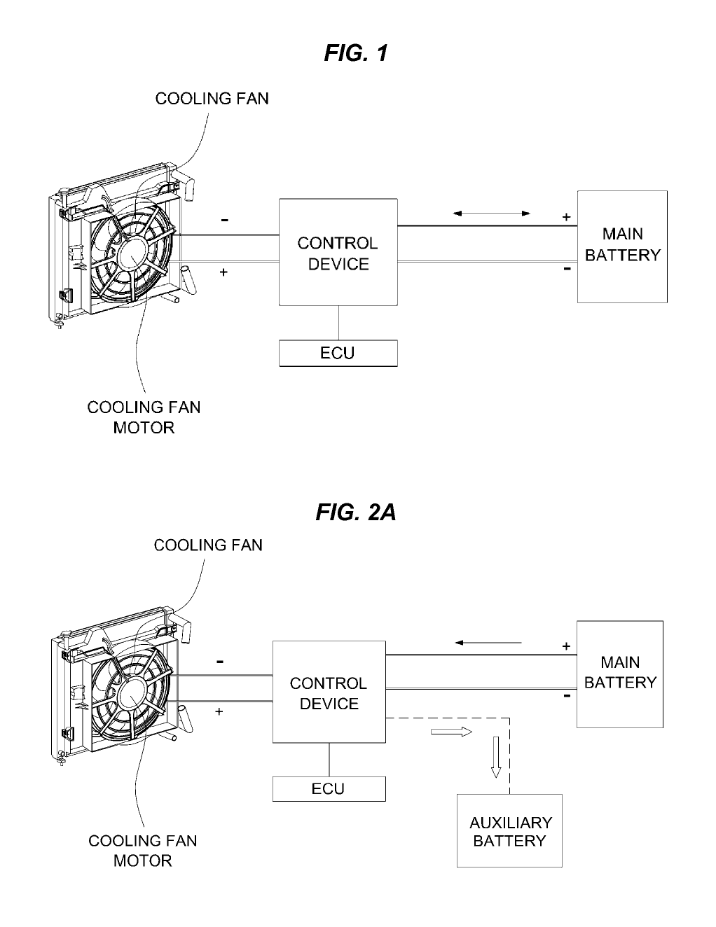

As described above, a cooling fan mounted on the vehicle is coupled to a rotor of the cooling fan motor. The cooling fan motor is operated by receiving power from a main battery as shown in FIG. 1 and operates in a cooling mode or a power generation mode according to control performed by a control device. That is, when an engine ECU senses the temperature of cooling water and transmits sensed data to the control device, the control device applies the power of the main battery to the cooling fan motor, which is operated in the cooling mode to allow more outside air to be introduced into a heat exchanger and controls the cooling fan motor to be operated in the power generation mode according to the speed of the vehicle and external temperature (in the case in which it is not required to cool the cooling water). In the cooling fan motor, the cooling fan is rotated by wind power of the outside air introduced according to the traveling of the vehicle, so that the rotor rotates the motor to produce electricity.

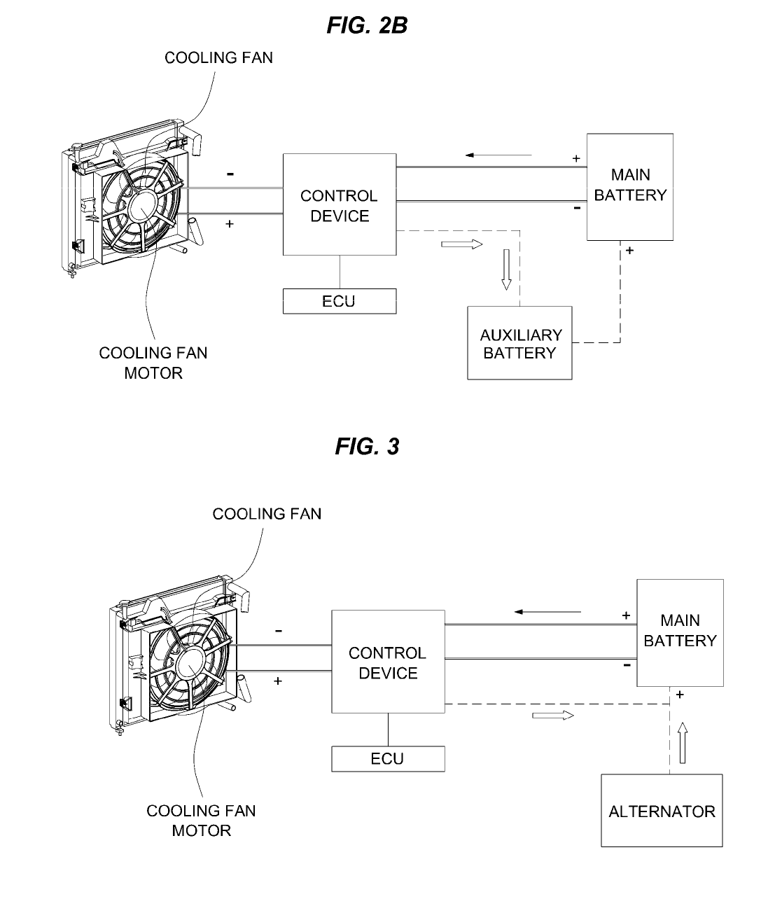

As shown in FIG. 1, the electricity produced by the cooling fan motor is charged in the main battery or as shown in FIG. 2A, the electricity is stored in an auxiliary battery additionally mounted. In addition, the auxiliary battery is wired so as to supply to the main battery or receive the electricity stored in the auxiliary battery (according to each charging state), as shown in FIG. 2B. Therefore, the electricity stored in the auxiliary battery may be configured to be supplied to electrical devices of the vehicle using the power of the main battery. In addition, various embodiments, as shown in FIG. 3, the electricity produced by the cooling fan motor is connected to a charging circuit of an alternator charging the main battery according to the rotation of the engine to be charged in the main battery.

Meanwhile, the control device is set to determine an operation mode of the cooling fan motor according to a predetermined control logic. That is, the control logic is in advance determined for each condition suitable for each situation by using the temperature of the cooling water and the speed of the vehicle, and an on/off state of an air-conditioning apparatus and the pressure of an air-conditioner (refrigerant) as variables to be inputted into the control device and the temperature of the cooling water and the speed of the vehicle are sensed by a water temperature sensor, a vehicle speed sensor, an outside temperature sensor, and the like to be transmitted to the control device.

For reference, a heat exchange of the air-conditioning apparatus of the vehicle is generally positioned in front of a heat exchanger of the cooling water and since liquefaction efficiency of the refrigerant depends on the rotation speed of the cooling fan motor, the variables of the control logic may further include the internal pressure of the heat exchanger of the air-conditioning apparatus. If the pressure of the refrigerant which is in a gaseous state is lower than a predetermined reference, the refrigerant is being efficiently liquefied, and therefore the cooling fan motor may be configured to operate in a power generation mode. On the contrary, if the pressure of the gaseous refrigerant is higher than the predetermined reference, the cooling fan motor may be configured to operate in a cooling mode.

In addition, the control logic employs a control logic of the known cooling fan motor and may be configured to operate in the power generation mode when the cooling fan motor is idle.

That is, the wind power generating system for a vehicle using the cooling fan motor according to various embodiments of the present invention may be generally used in the power generation mode as outside air is sufficiently introduced under a high-speed driving condition (e.g., higher than a predetermined speed). Accordingly, this system more efficient in the high-speed driving than in the driving in the city and may further improve fuel efficiency in the high-speed driving.

Meanwhile, the wind power generating system according to various embodiments of the present invention may be applied to all vehicles with the cooling fan motor (including a future-generation electric vehicle, a fuel cell vehicle, and the like) in addition to a general internal combustion engine vehicle and an additional fan (only for the power generation mode) may be mounted on the wind power generating system in order to improve the efficiency of the power generation mode. In addition, the sensing data required to control the cooling motor, such as the temperature of the cooling water an the speed of the vehicle may be configured such that data sensed by the engine ECU, a full automatic temperature control (FATC), a hybrid control unit (HCU), and the like are collected in the control device, thereby excluding addition of devices having the same function.

For convenience in explanation and accurate definition in the appended claims, the terms front and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A wind power generating system for a vehicle using a cooling fan motor that receives power from a main battery, the system comprising:
a cooling fan motor operated in a cooling mode to cool a heat exchanger with applied power from the main battery or operated in a power generation mode to produce electricity by rotating a cooling fan by driving wind; and
a control device controlling rotation of the cooling fan motor and determining whether the cooling fan motor is operated in the power generation mode or the cooling mode;
wherein the control device determines the operation of the cooling fan motor according to a predetermined control logic and the control logic is in advance determined for each condition by using the temperature of cooling water and the speed of the vehicle as variables.

2. The wind power generating system for a vehicle using a cooling fan motor of claim 1, wherein the control device stores in the main battery the electricity produced from the cooling fan motor operated in the power generation mode.

3. The wind power generating system for a vehicle using a cooling fan motor of claim 2, the system further comprising an auxiliary battery storing electricity;
wherein the control device stores in the main battery or the auxiliary battery the electricity produced from the cooling fan motor operated in the power generation mode.

4. The wind power generating system for a vehicle using a cooling fan motor of claim 3, wherein the auxiliary battery and the main battery are wired to exchange the stored electricity according to a charging state of each battery.

5. The wind power generating system for a vehicle using a cooling fan motor of claim 2, wherein a charging circuit of an alternator charging the main battery is connected to the control device and the electricity produced from the cooling fan motor operated in the power generation mode is charged in the main battery through the charging circuit of the alternator.

6. The wind power generating system for a vehicle using a cooling fan motor of claim 1, wherein the variables of the control logic further include refrigerant pressure of an air-conditioning apparatus and an on/off state of the air-conditioning apparatus.

7. The wind power generating system for a vehicle using a cooling fan motor of claim 6, wherein the control device communicates with a controller of other devices that sense data regarding the temperature of the cooling water, the speed of the vehicle, the refrigerant pressure, and the on/off state of the air-conditioning apparatus.
